(19) United States
(12) Patent Application Publication
(10) Pub. No.: US 2021/0325227 A1
(43) Pub. Date: Oct. 21, 2021

(54) PHYSICAL QUANTITY MEASUREMENT DEVICE

(71) Applicant: DENSO CORPORATION, Kariya-city (JP)

(72) Inventors: Akiyuki SUDOU, Kariya-city (JP); Kengo ITOU, Kariya-city (JP)

(21) Appl. No.: 17/233,903

(22) Filed: Apr. 19, 2021

(30) Foreign Application Priority Data
Apr. 21, 2020 (JP) 2020-075594

(51) Int. Cl. G01F 15/00; G01K 13/024

(52) U.S. Cl. CPC G01F 15/00; G01K 13/024

(57) ABSTRACT

A physical quantity measurement device includes a housing and a substrate. The substrate has a first mounting portion on which a flow rate detecting element is mounted, and a second mounting portion on which the temperature detecting element is mounted. The second mounting portion is supported by a measuring portion of the housing in a cantilever structure. A width of the second mounting portion over an entire area of a root side part is larger than a width of the second mounting portion at a position of the temperature detecting element, and increases as it approaches the root. The entire area of the first side surface and the second side surface at the root side part is composed of one flat surface extending from the position of the root toward the tip part side.

### CROSS REFERENCE TO RELATED APPLICATION

The present application is based on Japanese Patent Application No. 2020-075594 filed on Apr. 21, 2020, disclosure of which are incorporated herein by reference.

### TECHNICAL FIELD

The present disclosure relates to a physical quantity measurement device.

### BACKGROUND

A physical quantity measurement device includes a housing and a substrate fixed to the housing.

### SUMMARY

An object of the present disclosure is to provide a flow rate measurement device capable of suppressing damage to a second mounting portion due to vibration.

According to a first aspect of the present disclosure, in order to achieve the above object, a physical quantity measurement device for measuring a physical quantity of air flowing through a main flow path incudes a housing and a substrate fixed to the housing.

The substrate has a first mounting portion on which a physical quantity detecting element for detecting the physical quantity of air is mounted, and a second mounting portion on which a temperature detecting element for detecting the temperature of air is mounted.

In the second mounting portion, a tip part of the second mounting portion is a free end, and an end part of the second mounting portion on a side away from the tip part is a fixed end fixed to the housing so that the second mounting portion is supported by the housing.

The end part to be the fixed end of the second mounting portion is a root.

The second mounting portion has a root side part that is located on the root side of the temperature detecting element in the second mounting portion and includes the root.

The second mounting portion has a first surface on which the temperature detecting element is mounted, a second surface on the opposite side of the first surface, a first side surface connected to the first surface and the second surface, and a second side surface that is located at a position opposite to the first side surface and connected to the first surface and the second surface.

A width of the second mounting portion is a distance between the first side surface and the second side surface in a direction perpendicular to an extending direction of the second mounting portion from the root side to the tip part side.

The width of the second mounting portion over the entire area of a root side part is larger than a width of the second mounting portion at a position of the temperature detecting element, and increases as it approaches the root.

The entire area of the first side surface and the second side surface at the root side part is composed of one flat surface extending from the position of the root toward the tip part side.

Further, according to a second aspect of the present disclosure, a physical quantity measurement device for measuring a physical quantity of air flowing through a main flow path incudes a housing and a substrate fixed to the housing.

The substrate has a first mounting portion on which a physical quantity detecting element for detecting the physical quantity of air is mounted, and a second mounting portion on which a temperature detecting element for detecting the temperature of air is mounted.

In the second mounting portion, a tip part of the second mounting portion is a free end, and an end part of the second mounting portion on a side away from the tip part is a fixed end fixed to the housing so that the second mounting portion is supported by the housing.

The end part to be the fixed end of the second mounting portion is a root.

The second mounting portion has a root side part that is located on the root side of the temperature detecting element in the second mounting portion and includes the root.

The second mounting portion has a first surface on which the temperature detecting element is mounted, a second surface on the opposite side of the first surface, a first side surface connected to the first surface and the second surface, and a second side surface that is located at a position opposite to the first side surface and connected to the first surface and the second surface.

A thickness of the second mounting portion is a distance between the first surface and the second surface in a direction perpendicular to an extending direction of the second mounting portion from the root side to the tip part side.

The thickness of the second mounting portion over the entire area of the root side part is larger than the thickness of the second mounting portion at a position of the temperature detecting element.

### BRIEF DESCRIPTION OF DRAWINGS

FIG. 1 is a diagram showing an engine system to which a physical quantity measurement device of a first embodiment is applied;

FIG. 2 is a front view of the physical quantity measurement device of the first embodiment in a state of being attached to an intake pipe;

FIG. 3 is a side view of the physical quantity measurement device of FIG. 2;

FIG. 4 is a side view of the physical quantity measurement device of FIG. 2;

FIG. 5 is a cross-sectional view taken along a line V-V of FIG. 2;

FIG. 6 is an enlarged view of portion VI of FIG. 2;

FIG. 7 is an enlarged view of portion VII of FIG. 3;

FIG. 8 is an enlarged view of a second mounting portion of the physical quantity measurement device of a comparative example 1;

FIG. 9 is an enlarged view of a second mounting portion of the physical quantity measurement device of a comparative example 2;

FIG. 10 is a cross-sectional view of a second mounting portion of the physical quantity measurement device of the first embodiment;

FIG. 11 is a cross-sectional view of the second mounting portion of the physical quantity measurement device of the first embodiment;

FIG. 12 is an enlarged view of a second mounting portion of the physical quantity measurement device of a second embodiment and a peripheral portion thereof, and is a diagram corresponding to FIG. 7;

FIG. 13 is an enlarged view of a second mounting portion of the physical quantity measurement device of a third embodiment and a peripheral portion thereof, and is a diagram corresponding to FIG. 7;

FIG. 14 is an enlarged view of a second mounting portion of the physical quantity measurement device of a fourth embodiment and a peripheral portion thereof, and is a diagram corresponding to FIG. 7;

FIG. 15 is an enlarged view of a second mounting portion of the physical quantity measurement device of a fifth embodiment and a peripheral portion thereof, and is a diagram corresponding to FIG. 6;

FIG. 16 is an enlarged view of a second mounting portion of the physical quantity measurement device of the fifth embodiment and a peripheral portion thereof, and is a diagram corresponding to FIG. 7; and

FIG. 17 is a cross-sectional view of the physical quantity measurement device of a sixth embodiment, and is a diagram corresponding to FIG. 5.

### DETAILED DESCRIPTION

In an assumable example, a physical quantity measurement device includes a housing and a substrate fixed to the housing. The substrate has a first mounting portion on which a flow rate detecting element for detecting the flow rate of air is mounted, and a second mounting portion on which a temperature detecting element for detecting the temperature of air is mounted. The second mounting portion has a cantilever structure in which a tip part of the second mounting portion is a free end and an end part on the side away from the tip part of the second mounting portion is a fixed end fixed to the housing. The second mounting portion is supported by the housing.

In the above-mentioned example, if a vibration resistance performance of the second mounting portion is low, there is a concern that the second mounting portion may be damaged when vibration is applied to the physical quantity measurement device. An object of the present disclosure is to provide a flow rate measurement device capable of suppressing damage to the second mounting portion due to vibration.

According to a first aspect of the present disclosure, in order to achieve the above object, a physical quantity measurement device for measuring a physical quantity of air flowing through a main flow path incudes a housing and a substrate fixed to the housing.

The substrate has a first mounting portion on which a physical quantity detecting element for detecting the physical quantity of air is mounted, and a second mounting portion on which a temperature detecting element for detecting the temperature of air is mounted.

In the second mounting portion, a tip part of the second mounting portion is a free end, and an end part of the second mounting portion on a side away from the tip part is a fixed end fixed to the housing so that the second mounting portion is supported by the housing.

The end part to be the fixed end of the second mounting portion is a root.

The second mounting portion has a root side part that is located on the root side of the temperature detecting element in the second mounting portion and includes the root.

The second mounting portion has a first surface on which the temperature detecting element is mounted, a second surface on the opposite side of the first surface, a first side surface connected to the first surface and the second surface, and a second side surface that is located at a position opposite to the first side surface and connected to the first surface 61 and the second surface.

The width of the second mounting portion is a distance between the first side surface and the second side surface in a direction perpendicular to an extending direction of the second mounting portion from the root side to the tip part side.

A width of the second mounting portion over the entire area of a root side part is larger than a width of the second mounting portion at a position of the temperature detecting element, and increases as it approaches the root.

The entire area of the first side surface and the second side surface at the root side part is composed of one flat surface extending from the position of the root toward the tip part side.

According to this configuration, the width of the second mounting portion over the entire area of the root side part is larger than the width of the second mounting portion at the position of the temperature detecting element, and increases as it approaches the root. Therefore, a vibration resistance performance of the second mounting portion is improved as compared with the case where the width of the second mounting portion in the entire area of the second mounting portion is the same as the width of the second mounting portion at the position of the temperature detecting element.

The entire area of the first side surface and the second side surface at the root side part is composed of one flat surface extending from the position of the root toward the tip part side. Each of the first side surface and the second side surface at the root side part does not have a bent part near at a right angle. Therefore, it is possible to avoid the stress concentration that occurs in the bent part when the bent part is provided at a right angle to the root side part. As a result, damage to the second mounting portion due to vibration can be suppressed.

Further, according to a second aspect of the present disclosure, a physical quantity measurement device for measuring a physical quantity of air flowing through a main flow path incudes a housing and a substrate fixed to the housing.

The substrate has a first mounting portion on which a physical quantity detecting element for detecting the physical quantity of air is mounted, and a second mounting portion on which a temperature detecting element for detecting the temperature of air is mounted.

In the second mounting portion, a tip part of the second mounting portion is a free end, and an end part of the second mounting portion on a side away from the tip part is a fixed end fixed to the housing so that the second mounting portion is supported by the housing.

The end part to be the fixed end of the second mounting portion is a root.

The second mounting portion has a root side part that is located on the root side of the temperature detecting element in the second mounting portion and includes the root.

The second mounting portion has a first surface on which the temperature detecting element is mounted, a second surface on the opposite side of the first surface, a first side surface connected to the first surface and the second surface, and a second side surface that is located at a position opposite to the first side surface and connected to the first surface 61 and the second surface.

A thickness of the second mounting portion is a distance between the first surface and the second surface in a direction perpendicular to an extending direction of the second mounting portion from the root side to the tip part side.

The thickness of the second mounting portion over the entire area of the root side part is larger than the thickness of the second mounting portion at a position of the temperature detecting element.

According to this configuration, the thickness of the second mounting portion in the entire area of the root side part is larger than the thickness of the second mounting portion at the position of the temperature detecting element. Therefore, a vibration resistance performance of the second mounting portion is improved as compared with the case where the thickness of the second mounting portion in the entire area of the second mounting portion is the same as the thickness of the second mounting portion at the position of the temperature detecting element. Therefore, damage to the second mounting portion due to vibration can be suppressed.

A reference numeral in parentheses attached to each configuration element or the like indicates an example of correspondence between the configuration element or the like and the specific configuration element or the like described in embodiments below.

Hereinafter, embodiments of the present disclosure will be described with reference to the drawings. In the following embodiments, the same or equivalent parts are denoted by the same reference numerals.

### First Embodiment

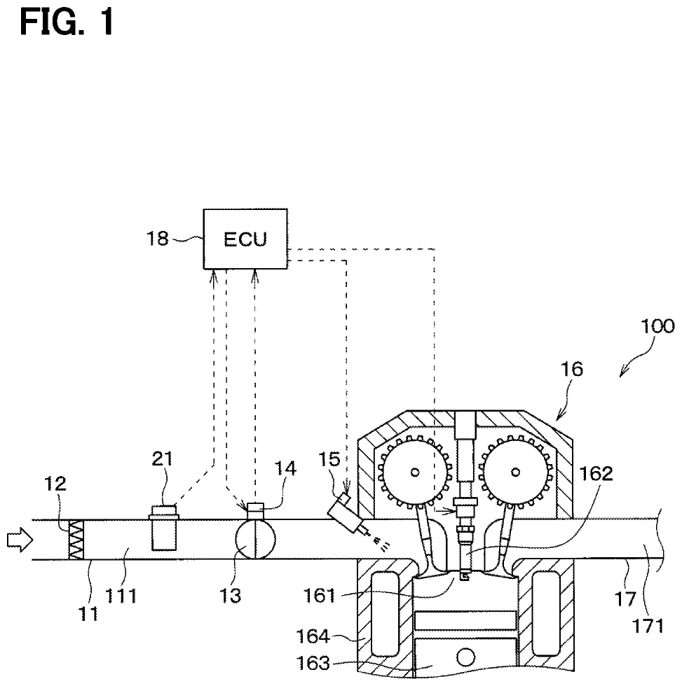

As shown in FIG. 1, the physical quantity measurement device 21 is used for an intake system of an engine system 100 mounted on a vehicle. First, the engine system 100 will be described.

The engine system 100 includes an intake pipe 11, an air cleaner 12, a physical quantity measurement device 21, a throttle valve 13, a throttle sensor 14, an injector 15, an engine 16, an exhaust pipe 17, and an electronic control unit 18. An intake air is the air taken into the engine 16. Further, an exhaust is a gas discharged from the engine 16.

The intake pipe 11 is formed in a cylindrical shape. The intake pipe 11 has a main flow path 111 through which intake air flows. The air cleaner 12 removes foreign matter such as dust contained in the air flowing through the main flow path 111. The physical quantity measurement device 21 is attached to the intake pipe 11. The physical quantity measurement device 21 measures a physical quantity such as a flow rate of air flowing through the main flow path 111 between the air cleaner 12 and the throttle valve 13. The throttle valve 13 adjusts a flow path area of the main flow path 111 to adjust the flow rate of the air sucked into the engine 16. The throttle sensor 14 outputs a detection signal according to an opening degree of the throttle valve 13 to the electronic control unit 18. The injector 15 injects fuel into a combustion chamber 161 of the engine 16 based on the signal from the electronic control unit 18.

The engine 16 is an internal combustion engine. In the combustion chamber 161 a mixture of intake air and fuel is ignited by a spark plug 162 and burned. Due to the explosive force during combustion, a piston 163 of the engine 16 reciprocates in a cylinder 164. The exhaust gas discharged from the combustion chamber 161 flows through an exhaust flow path 171 inside the exhaust pipe 17.

The electronic control unit 18 is mainly composed of a computer or the like, and includes a CPU, a ROM, a RAM, an I/O, a bus line for connecting these configurations, and the like. The electronic control unit 18 controls the opening degree of the throttle valve 13 based on the air flow rate measured by the physical quantity measurement device 21 and the opening degree of the throttle valve 13. Further, the electronic control unit 18 controls a fuel injection amount of the injector 15 and an ignition timing of the spark plug 162 based on the air flow rate measured by the physical quantity measurement device 21, the opening degree of the throttle valve 13 and the like. In FIG. 1, the electronic control unit 18 is described as an ECU.

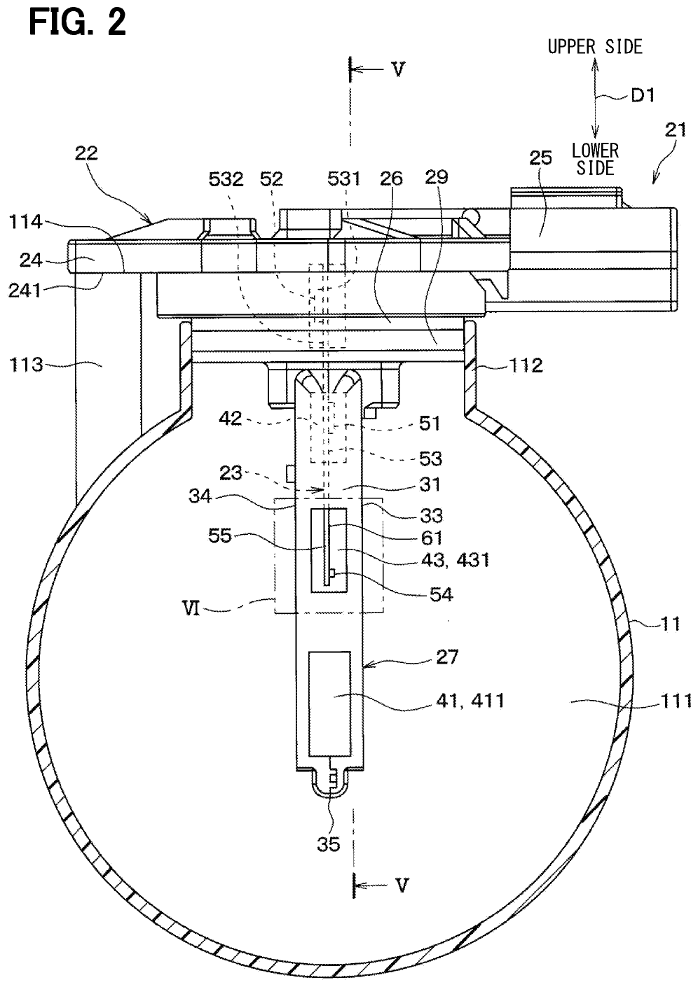

Next, the details of the physical quantity measurement device 21 will be described. As shown in FIGS. 2 to 5, the physical quantity measurement device 21 includes a housing 22 and a substrate 23. A first direction D1 in each figure is a direction perpendicular to a flange fastening surface 241 described later. A second direction D2 in each figure is a direction along the air flow of the main flow path 111.

As shown in FIG. 2, the housing 22 is attached to a pipe extension part 112 connected to a side surface of the intake pipe 11. The pipe extension part 112 is formed in a cylindrical shape, and extends from the side surface of the intake pipe 11 in the direction from a radial inner side to a radial outer side of the intake pipe 11. The housing 22 is made of a resin member mainly containing a synthetic resin. The housing 22 is formed by insert molding, which is resin molding with the substrate 23 placed in a mold.

The housing 22 has a flange portion 24, a connector portion 25, a closing portion 26, and a measuring portion 27. In the state where the physical quantity measurement device 21 is attached to the intake pipe 11, the flange portion 24 and the connector portion 25 are arranged outside the intake pipe 11. The closing portion 26 is arranged inside the pipe extension part 112. The measuring portion 27 is arranged in the main flow path 111 inside the intake pipe 11.

The flange portion 24 is a portion for fixing the housing 22 to the intake pipe 11. The flange portion 24 has the flange fastening surface 241 on the main flow path 111 side of the flange portion 24, which is fastened in contact with a boss part 113 of the intake pipe 11 as a mating part.

The boss part 113 projects from an outer surface of the intake pipe 11. The boss part 113 has a boss fastening surface 114 that is fastened in contact with the flange portion 24 at a tip. Fastening hole (not shown) is respectively formed on the flange fastening surface 241 and the boss fastening surface 114. Screw is inserted into the fastening hole of the flange fastening surface 241 and the fastening hole of the boss fastening surface 114. As a result, the flange portion 24 and the boss part 113 are fastened.

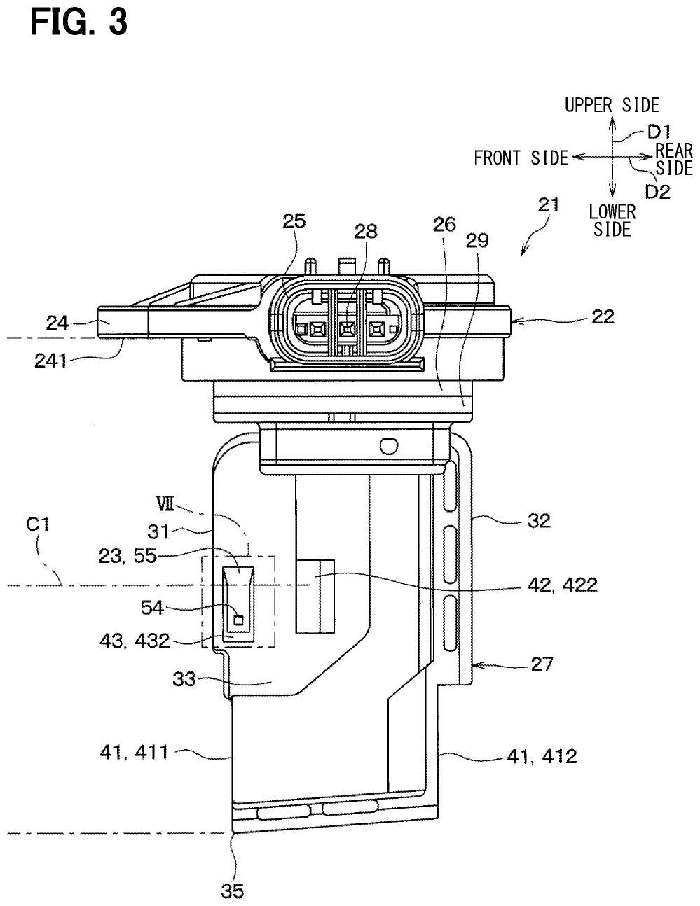

The connector portion 25 is a portion for electrical connection with an external device. As shown in FIG. 3, the connector portion 25 is formed in a tubular shape. One end of the terminals 28 is arranged inside the connector portion 25. One end of the terminals 28 is electrically connected to the electronic control unit 18. Although not shown, the other end of the terminals 28 is electrically connected to the substrate 23.

The closing portion 26 is a portion that closes the pipe extension part 112 in a state where the physical quantity measurement device 21 is attached to the pipe extension part 112. An annular seal member 29 is installed on an outer surface of the closing portion 26.

The measuring portion 27 is a portion for measuring physical quantities such as intake flow rate, temperature, and the like. The measuring portion 27 is arranged in the main flow path 111 in a state where the physical quantity measurement device 21 is attached to the intake pipe 11. The measuring portion 27 extends from the closing portion 26 toward a center side of the main flow path 111 in a plate shape. That is, the measuring portion 27 extends in the plate shape along the first direction D1.

In the following, for convenience, a flange portion 24 side with respect to the measuring portion 27 is referred to as an upper side as shown by the arrow D1 in FIGS. 2 to 5. A side away from the flange portion 24 with respect to the measuring portion 27 is referred to as a lower side. As shown by the arrow D2 in FIGS. 3 to 5, an upstream side of the air flow of the main flow path 111 with respect to the measuring portion 27 is referred to as a front side. A downstream side of the air flow of the main flow path 111 with respect to the measuring portion 27 is referred to as a rear side.

As shown in FIGS. 2 to 4, the measuring portion 27 has a front surface 31, a rear surface 32, a first side surface 33, a second side surface 34, and a lower end portion 35. The front surface 31 is arranged on the upstream side of the air flow of the main flow path 111. The rear surface 32 is arranged on the downstream side of the air flow in the main flow path 111. The first side surface 33 connects the front surface 31 and the rear surface 32. The second side surface 34 is located on an opposite side of the first side surface 33 and connects the front surface 31 and the rear surface 32. The lower end portion 35 is the end part of the measuring portion 27 on the side farthest from the flange portion 24 in the first direction D1.

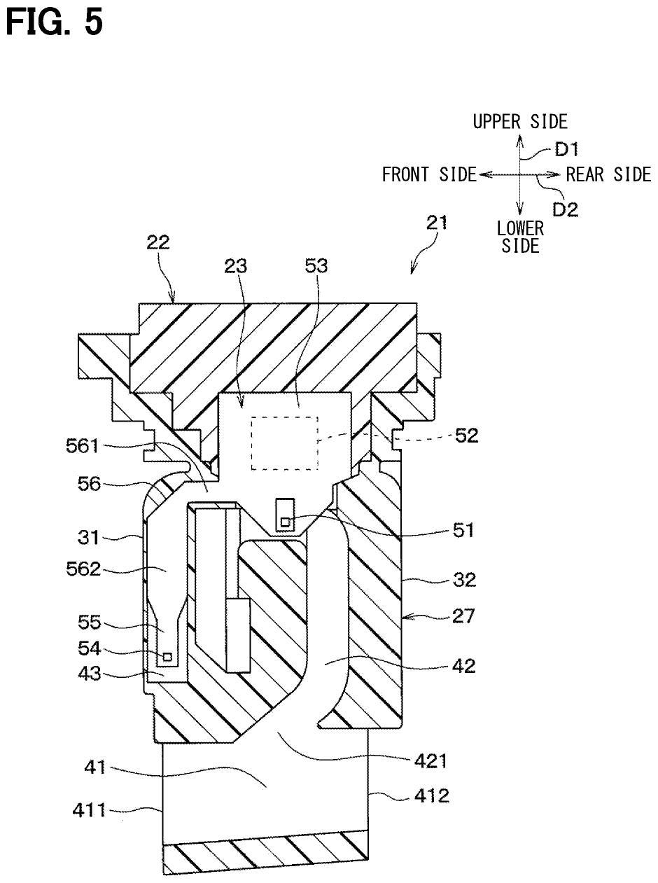

As shown in FIG. 5, the measuring portion 27 has a sub-flow path 41, a flow rate detection flow path 42, and a temperature detection flow path 43 inside.

The sub-flow path 41 is a flow path through which a part of the air flowing through the main flow path 111 flows. The sub-flow path 41 is arranged on the lower side of the measuring portion 27. The sub-flow path 41 has one inlet 411 and one outlet 412. The inlet 411 of the sub-flow path 41 is formed on the front surface 31. The outlet 412 of the sub-flow path 41 is formed on the rear surface 32. Air flows from the inlet 411 of the sub-flow path 41 toward the outlet 412.

The flow rate detection flow path 42 is a flow path for detecting the flow rate, and is a flow path branched from the sub-flow path 41. A part of the air flowing through the sub-flow path 41 flows through the flow rate detection flow path 42. The flow rate detection flow path 42 is arranged on the upper side and above the sub-flow path 41.

As shown in FIG. 5, the flow rate detection flow path 42 has one inlet 421. The inlet 421 is formed on the portion on the upper side of an inner wall surface forming the sub-flow path 41. The flow rate detection flow path 42 extends on the upper side from the inlet 421, then folds back to the front side, and extends on the lower side.

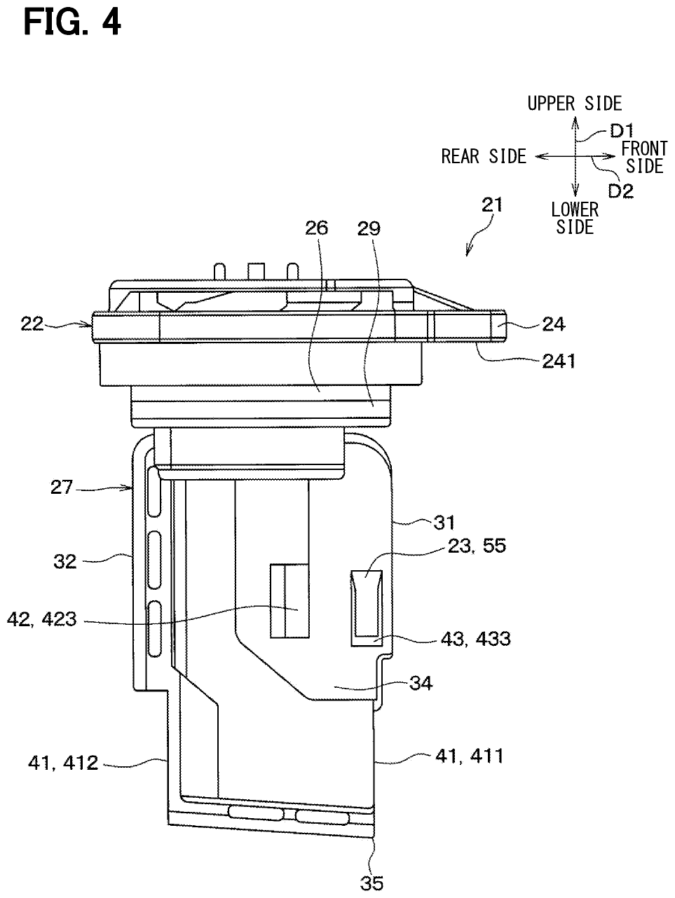

As shown in FIG. 3, the flow rate detection flow path 42 has a first outlet 422. The first outlet 422 is formed at a position on the upper side and above the sub-flow path 41 on the first side surface 33. As shown in FIG. 4, the flow rate detection flow path 42 has a second outlet 423. The second outlet 423 is formed at a position on the upper side and above the sub-flow path 41 on the second side surface 34.

The temperature detection flow path 43 is a flow path through which a part of the air flowing through the main flow path 111 flows, and is a flow path for detecting the temperature. The temperature detection flow path 43 is a flow path independent of the flow rate detection flow path 42. As shown in FIG. 5, the temperature detection flow path 43 is arranged on the upper side and above the sub-flow path 41. The temperature detection flow path 43 is arranged on the front side with respect to the flow rate detection flow path 42.

As shown in FIG. 2, the temperature detection flow path 43 has one inlet 431. The inlet 431 is formed at a position on the upper side and above the inlet 411 of the sub-flow path 41 on the front surface 31. As shown in FIG. 3, the temperature detection flow path 43 has a first outlet 432. The first outlet 432 is located on the upper side and above the sub-flow path 41 in the first side surface 33, and is formed on the front side with respect to the first outlet 422 of the flow rate detection flow path 42. As shown in FIG. 4, the temperature detection flow path 43 has a second outlet 433. The second outlet 433 is located on the upper side and above the sub-flow path 41 on the second side surface 34, and is formed on the front side with respect to the second outlet 423 of the flow rate detection flow path 42.

As shown in FIGS. 2 and 5, the substrate 23 is fixed to the housing 22 in a state where a part of the substrate 23 is covered by the housing 22. The substrate 23 is a printed circuit board in which wiring is formed on an insulating plate. As the printed circuit board, a glass epoxy board made of a composite material of glass fiber and epoxy resin is used. However, as the printed circuit board, a printed circuit board composed of other members may be used. Examples of those made of other members include ceramic substrates made of ceramics.

As shown in FIG. 5, the substrate 23 includes a first mounting portion 53 on which the flow rate detecting element 51 and the circuit unit 52 are mounted, a second mounting portion 55 on which the temperature detecting element 54 is mounted, and a connecting portion 56 for connecting the first mounting portion 53 and the second mounting portion 55. The flow rate detecting element 51 is an element that detects the flow rate of air, which is a physical quantity of air. The flow rate detecting element 51 outputs a signal corresponding to the flow rate of air. In the present embodiment, the flow rate detecting element 51 corresponds to a physical quantity detecting element that detects a physical quantity of air. The flow rate detection flow path 42 corresponds to the physical quantity detection flow path through which air for detecting the physical quantity flows. The temperature detecting element 54 is an element that detects the temperature of the air flowing through the temperature detection flow path 43. The temperature detecting element 54 outputs a signal corresponding to the temperature of the air. The circuit unit 52 processes the signals output from the flow rate detecting element 51 and the temperature detecting element 54.

A part of the first mounting portion 53 on which the flow rate detecting element 51 is mounted projects from the inner wall surface of the measuring portion 27 forming the flow rate detecting flow path 42 to the flow rate detection flow path 42. As a result, the flow rate detection element 51 is arranged in the flow rate detection flow path 42.

The second mounting portion 55 projects from the inner wall surface forming the temperature detection flow path 43 in the measuring portion 27 to the temperature detection flow path 43. As a result, the temperature detecting element 54 is arranged in the temperature detection flow path 43.

The connecting portion 56 has a first part 561 extending forward from the first mounting portion 53 and a second part 562 extending downward from the first part 561. A second mounting portion 55 is connected to the lower side of the second part 562 extending downward. The connecting portion 56 is sealed in a member constituting the measuring portion 27.

The substrate 23 is covered with the housing 22. Therefore, the heat transferred from the outside of the physical quantity measurement device 21 to the housing 22 is easily transferred from the housing 22 to the substrate 23. If the amount of heat transferred from the housing 22 to the temperature detecting element 54 is large, a detection accuracy of the temperature detecting element 54 decreases. Therefore, in the present embodiment, the temperature detecting element 54 is arranged in the second mounting portion 55 away from the first mounting portion 53. As a result, the influence of the detection accuracy of the temperature detecting element 54 due to the heat transfer from the housing 22 to the temperature detecting element 54 is reduced.

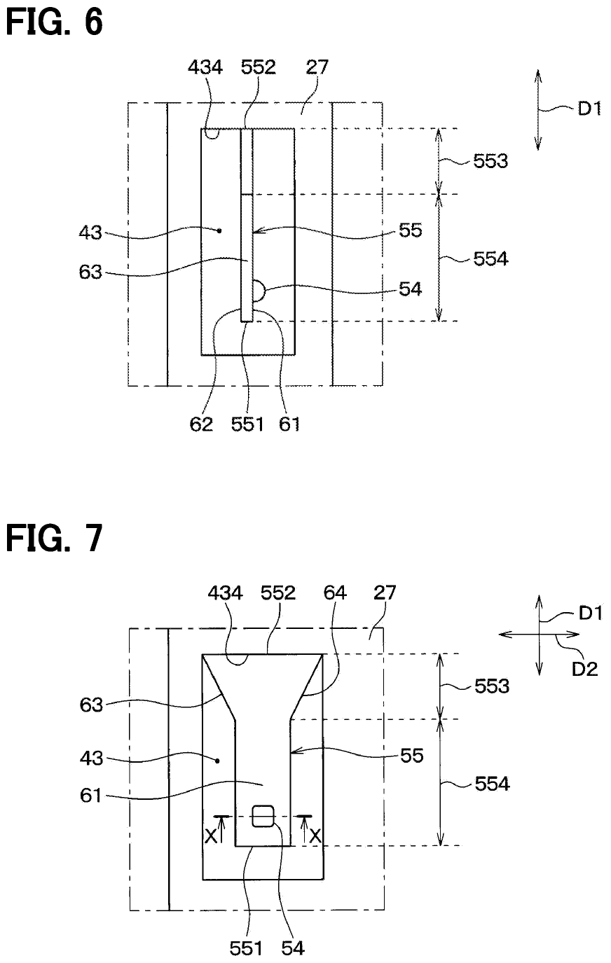

Next, the shape of the second mounting portion 55 will be described. As shown in FIGS. 6 and 7, the second mounting portion 55 extends downward from the upper part 434 of the inner wall surface forming the temperature detection flow path 43 in the measuring portion 27. In the second mounting portion 55, the tip part 551 of the second mounting portion 55 is a free end, and an end part of the second mounting portion 55 on the side away from the tip part 551 is a fixed end fixed to the measuring portion 27. In a cantilever structure described above, the second mounting portion 55 is supported by the measuring portion 27. The temperature detecting element 54 is mounted on the tip part 551 side with respect to a center position in the first direction D1 on the second mounting portion 55. The part becoming the fixed end in the second mounting portion 55 is a root 552 of the second mounting portion 55. An extending direction of the second mounting portion 55 from the root 552 side to the tip part 551 side is the first direction D1.

As shown in FIGS. 6 and 7, the second mounting portion 55 has a root side part 553 and an element side part 554. The root side part 553 is a part that is located on the root side with respect to the temperature detecting element 54 in the second mounting portion 55, and includes the root 552. The element side part 554 is a part that is located on the tip part 551 side with respect to the root side part 553 and on which the temperature detecting element 54 is arranged.

Further, the second mounting portion 55 has a first surface 61 on which the temperature detecting element 54 is mounted, a second surface 62 on the opposite side of the first surface 61, a first side surface 63 connected to the first surface 61 and the second surface 62, and a second side surface 64 that is located at a position opposite to the first side surface 63 and connected to the first surface 61 and the second surface 62. A distance between the first surface 61 and the second surface 62 in the direction perpendicular to the first direction D1 is a thickness of the second mounting portion 55. A distance between the first side surface 63 and the second side surface 64 in the direction perpendicular to the first direction D1 is a width of the second mounting portion 55.

As shown in FIG. 6, the thickness of the second mounting portion 55 is the same over the entire area. That is, the thickness of the second mounting portion 55 at the root side part 553 and the thickness of the second mounting portion 55 at the element side part 554 are the same.

As shown in FIG. 7, the width of the second mounting portion 55 in the entire area of the root side part 553 is larger than the width of the second mounting portion 55 in the element side part 554 and increases as it approaches the root 552 in the first direction D1. That is, the root side part 553 has a tapered shape. In other words, at the position of the second mounting portion 55 on the root side of the temperature detecting element 54, a part in which the width of the second mounting portion 55 is larger than the width of the second mounting portion 55 in the element side part 554 and increases as it approaches the root 552 in the first direction D1 is the root side part 553.

Then, the entire area of the first side surface 63 and the second side surface 64 on the root side part 553 is one flat surface extending diagonally from the position of the root 552 toward the tip part 551 side with respect to the first direction D1.

The width of the second mounting portion 55 at the element side part 554 is constant regardless of the distance from the root 552. That is, each of the first side surface 63 and the second side surface 64 on the element side part 554 is a flat surface extending parallel to the first direction D1.

Next, the measurement of the flow rate and the temperature by the physical quantity measurement device 21 will be described. A part of the air flowing through the main flow path 111 flows into the sub-flow path 41. A part of the air flowing through the sub-flow path 41 flows out from the outlet 412. The other part of the air flowing through the sub-flow path 41 flows into the flow rate detection flow path 42. The air flowing through the flow rate detection flow path 42 flows out from the first outlet 422 and the second outlet 423. At this time, the flow rate detecting element 51 outputs a signal corresponding to the flow rate of the air flowing through the flow rate detection flow path 42. The signal output from the flow rate detecting element 51 is processed by the circuit unit 52 and then transmitted to the electronic control unit 18 via the substrate 23 and the terminal 28.

Further, a part of the air flowing through the main flow path 111 flows into the temperature detection flow path 43. The air flowing through the temperature detection flow path 43 flows out from the first outlet 432 and the second outlet 433. At this time, the temperature detecting element 54 outputs a signal corresponding to the temperature of the air flowing through the temperature detection flow path 43. The signal output from the temperature detecting element 54 is processed by the circuit unit 52 and then transmitted to the electronic control unit 18 via the substrate 23 and the terminal 28.

Next, the operation and effect of the physical quantity measurement device 21 of the present embodiment will be described.

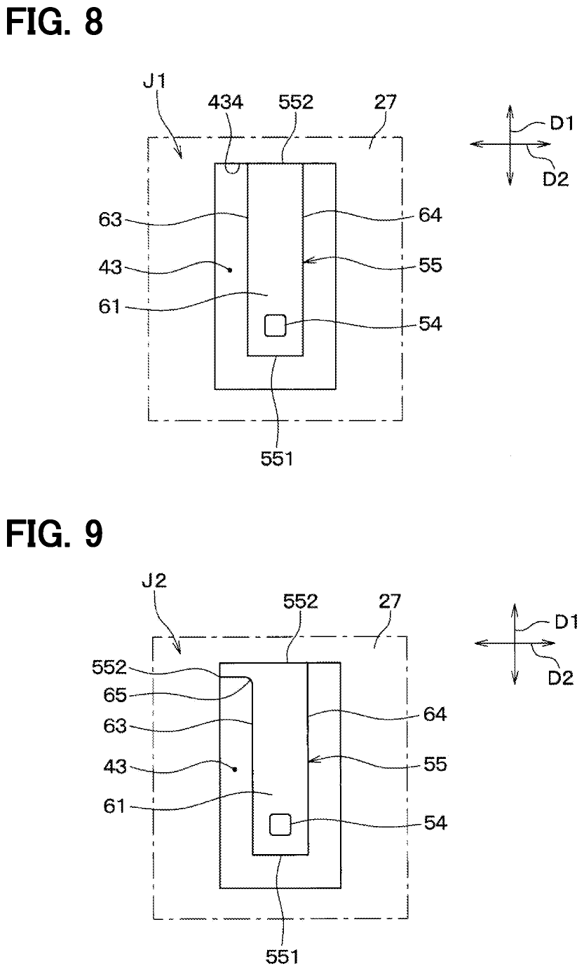

(1) The physical quantity measurement device 21 of the present embodiment is compared with the physical quantity measurement device J1 of a comparative example 1 shown in FIG. 8. In the comparative example 1, unlike the present embodiment, the width of the second mounting portion 55 is constant over the entire area of the second mounting portion 55. The width of the second mounting portion 55 in the comparative example 1 is the same as the width of the second mounting portion 55 at the position of the temperature detecting element 54 in the present embodiment. Other configurations of the comparative example 1 are the same as those of the present embodiment.

In the comparative example 1, similarly to the present embodiment, the second mounting portion 55 is supported by the measuring portion 27 in the cantilever structure. If a vibration resistance performance of the second mounting portion 55 is low, there is a concern that the second mounting portion 55 may be damaged when vibration is applied to the physical quantity measurement device 21.

On the other hand, according to the present embodiment, the width of the second mounting portion 55 over the entire area of the root side part 553 is larger than the width of the second mounting portion 55 at the position of the temperature detecting element 54, and increases as it approaches the root 552. Therefore, the vibration resistance performance of the second mounting portion 55 can be improved as compared with the comparative example 1. Therefore, damage to the second mounting portion 55 due to vibration can be suppressed.

(2) The physical quantity measurement device 21 of the present embodiment is compared with the physical quantity measurement device J2 of a comparative example 2 shown in FIG. 9. In the comparative example 2, in the root side part, the first side surface 63 has a bent part 65 near at a right angle. That is, the first side surface 63 extends in a plane from the position of the root 552 to the bent part 65 in a direction orthogonal to the extending direction of the second mounting portion 55 (that is, to the right in the drawing). The first side surface 63 is bent at a right angle at the bent part 65. The bent part 65 is curved. The first side surface 63 extends parallel to the first direction D1 from the bent part 65 toward the tip part 551.

In the comparative example 2, in a part of the second mounting portion 55 at the same position as the bent part 65 in the first direction D1, the width of the second mounting portion 55 increases as it approaches from the tip part 551 side to the root 552 side in the first direction D1.

However, when vibration is applied to the physical quantity measurement device 21, stress concentration may occur in the bent part 65, and damage may occur starting from the bent part 65. Therefore, in the comparative example 2, the vibration resistance performance of the second mounting portion 55 is low.

On the other hand, according to the present embodiment, the entire area of the first side surface 63 and the second side surface 64 on the root side part 553 is one flat surface extending from the position of the root 552 toward the tip part 551 side. Each of the first side surface 63 and the second side surface 64 at the root side part 553 does not have a bent part near at a right angle.

Therefore, the vibration resistance performance of the second mounting portion 55 can be improved as compared with the comparative example 2. This configuration also makes it possible to suppress damage to the second mounting portion 55 due to vibration.

(3) According to the present embodiment, as shown in FIG. 3, the temperature detecting element 54 is arranged below the center position Cl of the lower end portion 35 of the measuring portion 27 and the flange fastening surface 241 in the first direction D1 in the physical quantity measurement device 21. As a result, the temperature detecting element 54 can be arranged on the center side of the main flow path 111 in a state where the physical quantity measurement device 21 is attached to the intake pipe 11. Further, it is possible to reduce the influence of the detection accuracy due to the heat transfer from the flange portion 24 side of the housing 22 to the temperature detecting element 54.

(4) According to the present embodiment, the housing 22 is composed of a resin member mainly containing a synthetic resin. As shown in FIG. 5, the connecting portion 56 of the substrate 23 is sealed with a resin member constituting the housing 22.

According to this configuration, the resin member sealing the connecting portion 56 functions as a heat insulating material. Therefore, heat transfer from the circuit unit 52 to the second mounting portion 55 can be suppressed. It is possible to reduce the influence of the detection accuracy of the temperature detecting element 54 due to the heat transfer from the circuit unit 52.

(5) According to the present embodiment, as shown in FIG. 2, the first mounting portion 53 has a first surface 531 of the first mounting portion 53 located on the same side as the first surface 61 of the second mounting portion 55 with respect to the substrate 23 and a second surface 532 of the first mounting portion 53 on the opposite side of the first surface 531 of the first mounting portion 53. The circuit unit 52 is mounted on the second surface 532 of the first mounting portion 53.

According to this configuration, the circuit unit 52 is mounted on the surface of the substrate 23 opposite to the surface on which the temperature detecting element 54 is mounted. Therefore, as compared with a case where the temperature detecting element 54 and the circuit unit 52 are mounted on a surface on the same side of the substrate 23, it is possible to reduce the influence of the detection accuracy of the temperature detecting element 54 due to heat transfer from the circuit unit 52 to the temperature detecting element 54.

(6) As shown in FIG. 5, the temperature detecting element 54 is arranged on the upstream side in the air flow of the main flow path 111 with respect to the circuit unit 52. In FIG. 5, the air flow direction from the inlet 411 to the outlet 412 in the sub-flow path 41 is the same as the air flow direction in the main flow path 111.

In other words, the temperature detecting element 54 is located at a position different from the flow rate detection flow path 42, and is arranged on the upstream side in the air flow direction of the main flow path 111 with respect to the flow rate detection flow path 42. Further, in other words, the temperature detecting element 54 is arranged in the temperature detection flow path 43, which is a flow path different from the flow rate detection flow path 42.

According to this configuration, the temperature detecting element 54 can detect the temperature of the air that is not affected by the heat from the circuit unit 52. Therefore, the detection accuracy of the temperature detecting element 54 can be improved as compared with the case of detecting the temperature of the air affected by the heat from the circuit unit 52.

(7) As shown in FIG. 3, the temperature detecting element 54 is arranged on the downstream side in the air flow direction of the main flow path 111 with respect to the inlet 411 of the sub-flow path 41. According to this, the temperature detecting element 54 is located inside the measuring portion 27 with respect to the inlet 411 of the sub-flow path 41. Therefore, when the physical quantity measurement device 21 is attached to the intake pipe 11, it is possible to prevent the temperature detecting element 54 from colliding with the pipe extension part 112 of the intake pipe 11 which is the attachment part of the physical quantity measurement device 21 and being damaged. Further, according to this configuration, in a case where the temperature detecting element 54 is located on the upstream side of the main flow path 111 in the air flow direction with respect to the inlet 411 of the sub-flow path 41, it is possible to prevent the air flow turbulent by the temperature detecting element 54 from flowing into the sub-flow path 41 and the flow rate detection flow path 42. Therefore, the deterioration of the detection accuracy of the flow rate detecting element 51 can be avoided.

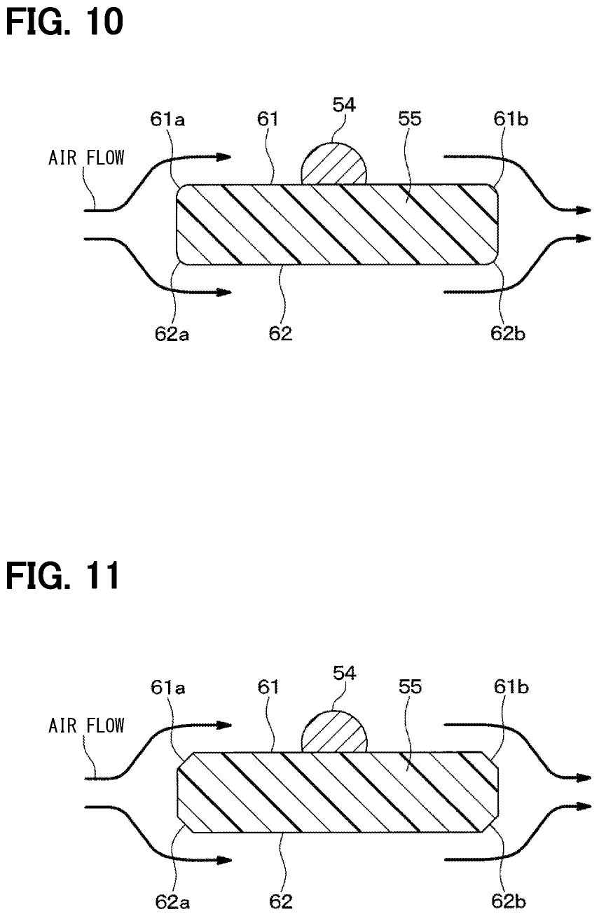

(8) As shown in FIG. 10, in the second mounting portion 55, a corner part 61a on the upstream side in the air flow and a corner part 61b on the downstream side in the air flow of the first surface 61 are curved surfaces. A corner part 62a on the upstream side in the air flow and a corner part 62b on the downstream side in the air flow of the second surface 62 are curved surfaces.

According to this configuration, as compared with the case where all of the corner parts 61a, 61b, 62a, 62b described above have a right angle, the air flow flowing along the second mounting portion 55 is stable as shown by the arrow in FIG. 10. Therefore, the detection accuracy of the temperature detecting element 54 can be improved.

As shown in FIG. 11, the corner part 61a on the upstream side in the air flow and a corner part 61b on the downstream side in the air flow of the first surface 61 may be flat surfaces oblique to the first surface 61. The corner part 62a on the upstream side in the air flow and the corner part 62b on the downstream side in the air flow of the second surface 62 may be flat surfaces oblique to the second surface 62. Even in this case, the air flow flowing along the second mounting portion 55 is more stable than in the case where all of the corner parts 61a, 61b, 62a, and 62b described above have the right angle.

Further, at least one of the above-mentioned corner parts 61a, 61b, 62a, 62b may be the curved surface or the oblique flat surface. In this case, only one of the curved surface and the oblique flat surface, or both may be adopted. According to this configuration, the air flow flowing along the second mounting portion 55 is more stable than in the case where all of the corner parts 61a, 61b, 62a, and 62b have the right angle.

### Second Embodiment

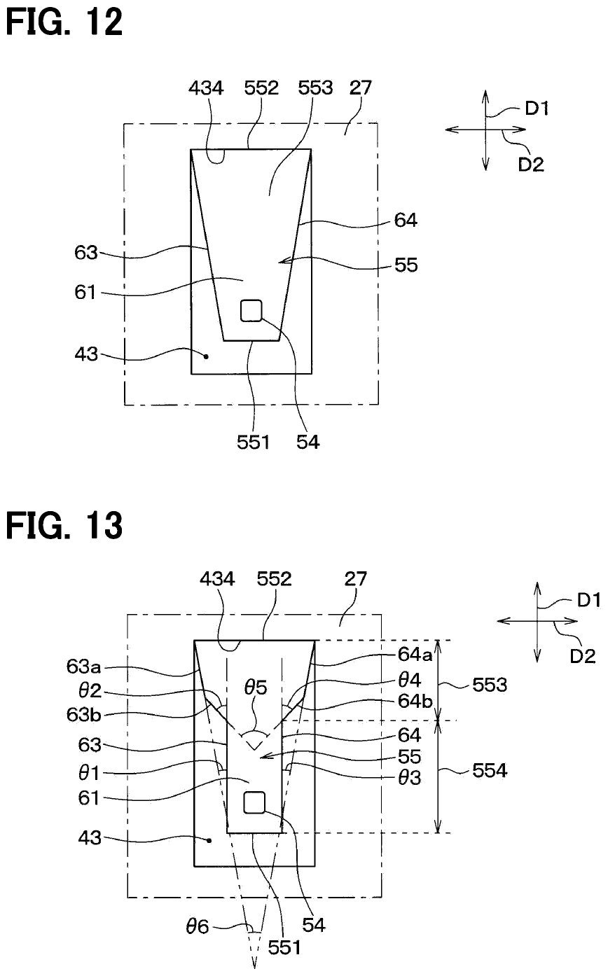

As shown in FIG. 12, in the present embodiment, the shape of the second mounting portion 55 is different from that in the first embodiment. In the entire area of the second mounting portion 55, the width of the second mounting portion 55 increases from the tip part 551 side to the root 552 side in the first direction D1. In the present embodiment, the width of the second mounting portion 55 of the root side part 553 is larger than the width of the second mounting portion 55 in the element side part 554 and increases as it approaches the root 552 in the first direction D1. Therefore, the effect (1) of the first embodiment can be obtained.

Further, in the present embodiment, the first side surface 63 is flat from the position of the root 552 to the position of the tip part 551. The second side surface 64 is also flat from the position of the root 552 to the position of the tip part 551. Therefore, the effect (2) of the first embodiment can be obtained.

The other configuration of the physical quantity measurement device 21 is the same as that of the first embodiment. Therefore, the effects (3) to (8) of the first embodiment can be obtained.

### Third Embodiment

As shown in FIG. 13, in the present embodiment, the shape of the element side part 554 of the second mounting portion 55 is the same as that in the first embodiment. However, the shape of the root side part 553 of the second mounting portion 55 is different from that of the first embodiment.

The first side surface 63 of the root side part 553 has a first flat part 63a connected to the root 552 and a second flat part 63b connected to the tip part 551 side with respect to the first flat part 63a. Each of the first flat part 63a and the second flat part 63b is inclined with respect to the first side surface 63 at the element side part 554.

A taper angle θ2 of the second flat part 63b is larger than a taper angle θ1 of the first flat part 63a. The taper angle θ2 of the second flat part 63b is an angle formed by the second flat part 63b with respect to the first side surface 63 on the element side part 554. More specifically, the taper angle θ2 of the second flat part 63b is formed between a virtual surface extending the first side surface 63 of the element side part 554 toward the root 552 side and the second flat part 63b, and is an acute angle formed on the root 552 side. Further, the taper angle θ1 of the first flat part 63a is an angle formed by the first flat part 63a with respect to the first side surface 63 on the element side part 554. More specifically, the taper angle θ1 of the first flat part 63a is formed by the virtual surface extending the first flat part 63a toward the tip part 551 side and the first flat part 63a, and is an acute angle formed on the root 552 side.

Similarly, the second side surface 64 of the root side part 553 has a third flat part 64a connected to the root 552 and a fourth flat part 64b connected to the tip part 551 side with respect to the third flat part 64a. Each of the third flat part 64a and the fourth flat part 64b is inclined with respect to the second side surface 64 at the element side part 554.

The taper angle θ4 of the fourth flat part 64b is larger than the taper angle θ3 of the third flat part 64a. The taper angle θ4 of the fourth flat part 64b is an angle formed by the fourth flat part 64b with respect to the second side surface 64 on the element side part 554. More specifically, the taper angle θ4 of the fourth flat part 64b is formed between the virtual surface extending the second side surface 64 of the element side part 554 to the root 552 side and the fourth flat part 64b, and an acute angle formed on the root 552 side. Further, the taper angle θ3 of the third flat part 64a is an angle formed by the third flat part 64a with respect to the second side surface 64 on the element side part 554. More specifically, the taper angle θ3 of the third flat part 64a is formed by the virtual surface extending the third flat part 64a toward the tip part 551 side and the third flat part 64a, and is an acute angle formed toward the root 552 side.

In other words, the first angle θ5 formed by the second flat part 63b and the fourth flat part 64b is larger than the second angle θ6 formed by the first flat part 63a and the third flat part 64a. The first angle θ5 is an angle formed by a virtual surface extending the second flat part 63b toward the tip part 551 and a virtual surface extending the fourth flat part 64b toward the tip part 551. The second angle θ6 is an angle formed by a virtual surface extending the first flat part 63a toward the tip part 551 and a virtual surface extending the third flat part 64a toward the tip part 551.

Also in the present embodiment, as in the first embodiment, the width of the second mounting portion 55 over the entire area of the root side part 553 is larger than the width of the second mounting portion 55 at the position of the temperature detecting element 54, and expands as it approaches the root 552. The entire area of the first side surface 63 at the root side part 553 is composed of a first flat part 63a and a second flat part 63b extending from the position of the root 552 toward the tip part 551 side as a plurality of flat surfaces. The entire area of the second side surface 64 at the root side part 553 is composed of a third flat part 64a and a fourth flat part 64b extending from the position of the root 552 toward the tip part 551 side as a plurality of flat surfaces. Each of the first side surface 63 and the second side surface 64 in the root side part 553 does not have a flat surface extending in the second direction D2 and does not have a bent portion close to a right angle. Therefore, the effect (1) and (2) of the first embodiment can be obtained.

The other configuration of the physical quantity measurement device 21 is the same as that of the first embodiment. Therefore, the effects (3) to (8) of the first embodiment can be obtained. According to the present embodiment, the following effects are further achieved.

The first angle θ5 formed by the second flat part 63b and the fourth flat part 64b is larger than the second angle θ6 formed by the first flat part 63a and the third flat part 64a. Therefore, as compared with the case where the angle formed by the first side surface 63 and the second side surface 64 on the root side part 553 is constant at the second angle θ6, the width of the second mounting portion 55 sharply narrows on the way from the root 552 to the temperature detecting element 54. The narrower the width of the mounting portion is, the more heat transfer through the substrate can be suppressed. Therefore, it is possible to suppress heat transfer from the root 552 toward the temperature detecting element 54.

### Fourth Embodiment

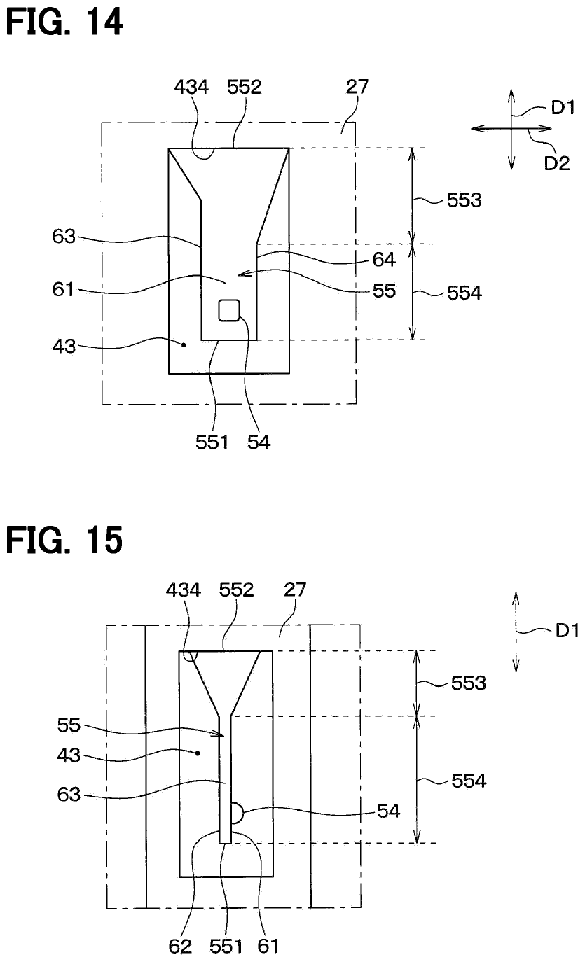

In the present embodiment, the shape of the second mounting portion 55 is different from that in the first embodiment. As shown in FIG. 14, the first side surface 63 at the root side part 553 and the second side surface 64 at the root side part 553 have an asymmetrical shape.

Also in the present embodiment, the width of the second mounting portion 55 over the entire area of the root side part 553 is larger than the width of the second mounting portion 55 at the position of the temperature detecting element 54, and increases as it approaches the root 552. The entire area of the first side surface 63 at the root side part 553 is composed of a flat surface oblique to the first direction D1 and a flat surface parallel to the first direction D1. As described above, the entire area of the first side surface 63 at the root side part 553 is composed of a plurality of flat surfaces extending from the position of the root 552 toward the tip part 551 side. The entire area of the second side surface 64 at the root side part 553 is composed of one flat surface extending from the position of the root 552 toward the tip part 551 side. Each of the first side surface 63 and the second side surface 64 in the root side part 553 does not have a flat surface extending in the second direction D2 and does not have a bent portion close to a right angle. Therefore, the effect (1) and (2) of the first embodiment can be obtained.

### Fifth Embodiment

In the present embodiment, the shape of the second mounting portion 55 is different from that in the first embodiment. As shown in FIG. 15, a thickness of the second mounting portion 55 over the entire area of the root side part 553 is larger than the thickness of the second mounting portion 55 at the position of the temperature detecting element 54, and expands as it approaches the root 552 in the first direction D1. The entire area of the first surface 61 and the second surface 62 at the root side part 553 is composed of one flat surface extending from the position of the root 552 toward the tip part 551 side, and does not have a bent portion close to a right angle.

The thickness of the second mounting portion 55 at the element side part 554 is constant regardless of the distance from the root 552. That is, each of the first surface 61 and the second surface 62 at the element side part 554 is a flat surface extending parallel to the first direction D1. In the present embodiment, the thickness of the second mounting portion 55 at the element side part 554 is the same as the thickness of the second mounting portion 55 of the comparative example 1.

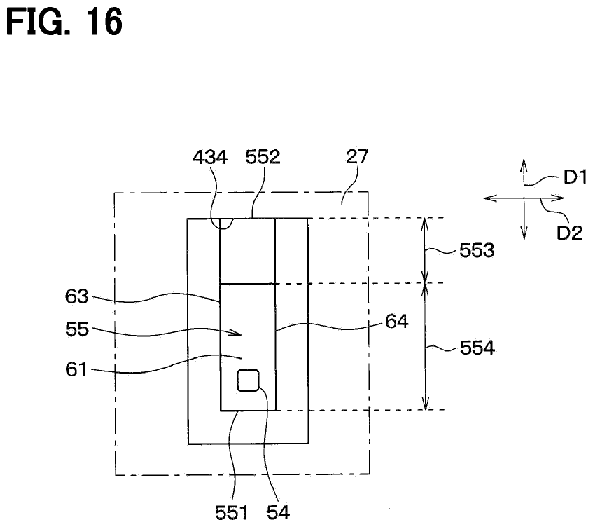

As shown in FIG. 16, the width of the second mounting portion 55 is the same over the entire area of the second mounting portion 55. In the present embodiment, the width of the second mounting portion 55 is the same as the width of the second mounting portion 55 of the comparative example 1.

The configuration of the physical quantity measurement device 21 other than the above is the same as that of the first embodiment. According to the present embodiment, the same effect as that of the first embodiment can be obtained.

In the present embodiment, each of the first surface 61 and the second surface 62 on the root side part 553 is a flat surface. However, each of the first surface 61 and the second surface 62 at the root side part 553 may be a curved surface.

Further, in the present embodiment, the entire area of the first surface 61 and the second surface 62 at the root side part 553 is composed of one flat surface extending from the position of the root 552 toward the tip part 551 side. However, as in the third embodiment, the entire area of the first surface 61 and the second surface 62 at the root side part 553 may be configured to be a plurality of flat surfaces extending from the position of the root 552 toward the tip part 551 side. Thereby, the same effect as in the third embodiment can be provided.

Further, in the present embodiment, the thickness of the second mounting portion 55 in the entire area of the root side part 553 increases as it approaches the root 552 in the first direction D1. However, when the thickness of the second mounting portion 55 over the entire area of the root side part 553 is larger than the thickness of the second mounting portion 55 at the position of the temperature detecting element 54, the thickness is constant regardless of the distance from the root 552. Therefore, the effect (1) of the first embodiment can be obtained.

### Sixth Embodiment

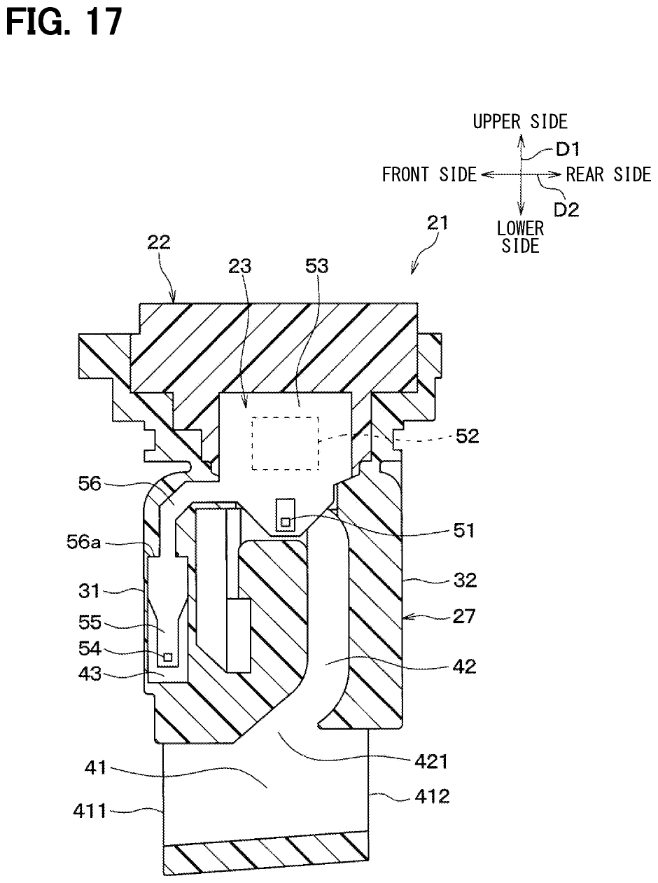

In the present embodiment, the shape of the connecting portion 56 of the substrate 23 is different from that of the first embodiment. As shown in FIG. 17, the surface of the connecting portion 56 has a step part 56a having a height difference on the surface. According to this configuration, the step part 56a can prevent the connecting portion 56 from being displaced with respect to the measuring portion 27.

### Other Embodiments

(1) In the first embodiment, the width of the second mounting portion 55 at the element side part 554 is constant regardless of the distance from the root 552. However, the width of the second mounting portion 55 at the element side part 554 does not have to be constant.

Similarly, in the fifth embodiment, the thickness of the second mounting portion 55 at the element side part 554 is constant regardless of the distance from the root 552. However, the thickness of the second mounting portion 55 at the element side part 554 does not have to be constant.

(2) In the first to fourth embodiments, both the first side surface 63 and the second side surface 64 at the root side part 553 are tilted with respect to the first direction D1. However, one of the first side surface 63 and the second side surface 64 at the root side part 553 may be tilted with respect to the first direction D1, and the other of the first side surface 63 and the second side surface 64 at the root side part 553 may be a flat surface parallel to the first direction D1. Even in this case, the other of the first side surface 63 and the second side surface 64 at the root side part 553 is composed of one flat surface extending from the position of the root 552 toward the tip part 551 side. Further, in the third embodiment, even when the second side surface 64 is a flat surface parallel to the first direction D1, a relationship is established in which the first angle θ5 formed by the second flat part 63b and the fourth flat part 64b is larger than the second angle θ6 formed by the first flat part 63a and the third flat part 64a. In this case, the third flat part 64a and the fourth flat part 64b are flat surfaces parallel to the first direction D1.

Similarly, in the fifth embodiment, both the first surface 61 and the second surface 62 at the root side part 553 are inclined with respect to the first direction D1. However, one of the first surface 61 and the second surface 62 at the root side part 553 may be inclined with respect to the first direction D1, and the other of the first surface 61 and the second surface 62 at the root side part 553 may be a flat surface parallel to the first direction D1. Even in this case, the other of the first surface 61 and the second surface 62 at the root side part 553 is composed of one flat surface extending from the position of the root 552 toward the tip part 551 side.

(3) In each of the above-described embodiments, the second mounting portion 55 is arranged in the temperature detection flow path 43 formed inside the measuring portion 27. However, the second mounting portion 55 may be arranged outside the measuring portion 27 by projecting from the front surface 31 of the measuring portion 27 to the front side. In this case, the extending direction of the second mounting portion 55 is the direction along the second direction D2.

(4) In each of the above-described embodiments, the flow rate detecting element 51 is used as the physical quantity detecting element. As the physical quantity detecting element, an element that detects a physical quantity other than temperature may be used.

(5) The present disclosure is not limited to the foregoing description of the embodiments and can be modified within the scope of the present disclosure. The present disclosure may also be varied in many ways. Such variations are not to be regarded as departure from the disclosure, and all such modifications are intended to be included within the scope of the disclosure. The embodiments described above are not independent of each other, and can be appropriately combined except when the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. Furthermore, in each of the above embodiments, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as indispensable or is obviously indispensable in view of the principle of the present disclosure. Furthermore, a material, a shape, a positional relationship, or the like, if specified in the above-described example embodiments, is not necessarily limited to the specific material, shape, positional relationship, or the like unless it is specifically stated that the material, shape, positional relationship, or the like is necessarily the specific material, shape, positional relationship, or the like, or unless the material, shape, positional relationship, or the like is obviously necessary to be the specific material, shape, positional relationship, or the like in principle.

What is claimed is:

1. A physical quantity measurement device configured to measure a physical quantity of air flowing through a main flow path, the physical quantity measurement device comprising:
a housing; and
a substrate fixed to the housing, wherein
the substrate has
a first mounting portion on which a physical quantity detecting element configured to detect the physical quantity of air is mounted, and
a second mounting portion on which a temperature detecting element configured to detect a temperature of air is mounted,
in the second mounting portion, a tip part of the second mounting portion is a free end, and an end part of the second mounting portion on a side away from the tip part is a fixed end fixed to the housing so that the second mounting portion is supported by the housing,
the end part to be the fixed end of the second mounting portion is a root,
the second mounting portion has a root side part that is located on the root side of the temperature detecting element in the second mounting portion and includes the root,
the second mounting portion includes
a first surface on which the temperature detecting element is mounted,
a second surface opposite the first surface,
a first side surface connected to the first surface and the second surface, and
a second side surface connected to the first surface and the second surface at a position opposite to the first side surface,
a width of the second mounting portion is a distance between the first side surface and the second side surface in a direction perpendicular to an extending direction of the second mounting portion from the root side to the tip part side,
the width of the second mounting portion over an entire area of the root side part is larger than the width of the second mounting portion at a position of the temperature detecting element, and expands as it approaches the root in the extending direction, and
an entire area of the first side surface and the second side surface at the root side part is composed of one or a plurality of flat surfaces extending from a position of the root to the tip part side.

2. A physical quantity measurement device configured to measure a physical quantity of air flowing through a main flow path, the physical quantity measurement device comprising:
a housing; and
a substrate fixed to the housing, wherein
the substrate has
a first mounting portion on which a physical quantity detecting element configured to detect the physical quantity of air is mounted, and
a second mounting portion on which a temperature detecting element configured to detect a temperature of air is mounted,
in the second mounting portion, a tip part of the second mounting portion is a free end, and an end part of the second mounting portion on a side away from the tip part is a fixed end fixed to the housing so that the second mounting portion is supported by the housing,
the end part to be the fixed end of the second mounting portion is a root,
the second mounting portion has a root side part that is located on the root side of the temperature detecting element in the second mounting portion and includes the root,
the second mounting portion includes
a first surface on which the temperature detecting element is mounted,
a second surface opposite the first surface,
a first side surface connected to the first surface and the second surface, and
a second side surface connected to the first surface and the second surface at a position opposite to the first side surface,
a thickness of the second mounting portion is a distance between the first surface and the second surface in a direction perpendicular to an extending direction of the second mounting portion from the root side to the tip part side, and
the thickness of the second mounting portion over an entire area of the root side part is larger than the thickness of the second mounting portion at a position of the temperature detecting element.

3. The physical quantity measurement device according to claim 2, wherein
the thickness of the second mounting portion over the entire area of the root side part increases as it approaches the root in the extending direction.

4. The physical quantity measurement device according to claim 3, wherein
an entire area of the first surface and the second surface at the root side part is composed of one or a plurality of flat surfaces extending from a position of the root to the tip part side.

5. The physical quantity measurement device according to claim 1, wherein
at least one of a corner part on an upstream side of the air flow and a corner part on a downstream side of the air flow on the first surface is a curved surface or a flat surface oblique to the first surface.

6. The physical quantity measurement device according to claim 1, wherein
at least one of a corner part on an upstream side of the air flow and a corner part on a downstream side of the air flow on the second surface is a curved surface or a flat surface oblique to the first surface.

7. The physical quantity measurement device according to claim 1, wherein
the housing has a measuring portion arranged in the main flow path and a flange portion for fixing the housing to a pipe having the main flow path,
the flange portion has a flange fastening surface that is fastened in contact with a part of the pipe, and
the temperature detecting element is arranged below a center position between an end portion of the measuring portion farthest from the flange portion and the flange fastening surface in a direction perpendicular to the flange fastening surface.

8. The physical quantity measurement device according to claim 1, wherein
the housing is made of a resin member mainly containing a synthetic resin,
a circuit unit that processes a signal output from the physical quantity detecting element and the temperature detecting element is mounted on the first mounting portion,
the substrate has a connecting portion that connects the first mounting portion and the second mounting portion, and
the connecting portion is sealed by the resin member.

9. The physical quantity measurement device according to claim 1, wherein
a circuit unit that processes a signal output from the physical quantity detecting element and the temperature detecting element is mounted on the first mounting portion,
the first mounting portion has a first surface of the first mounting portion on the same side as the first surface of the second mounting portion with respect to the substrate and a second surface of the first mounting portion on an opposite side of the first surface of the first mounting portion, and
the circuit unit is mounted on the second surface of the first mounting portion.

10. The physical quantity measurement device according to claim 1, wherein
a circuit unit that processes a signal output from the physical quantity detecting element and the temperature detecting element is mounted on the first mounting portion, and
the temperature detecting element is arranged on the upstream side of the air flow in the main flow path with respect to the circuit unit.

11. The physical quantity measurement device according to claim 1, wherein
a circuit unit that processes a signal output from the physical quantity detecting element and the temperature detecting element is mounted on the first mounting portion,
the housing has a physical quantity detection flow path through which air for detecting a physical quantity flows,
a part of the first mounting portion on which the physical quantity detecting element is mounted is arranged in the physical quantity detection flow path, and
the temperature detecting element is located at a position different from a flow rate detection flow path, and is arranged on the upstream side in the air flow direction of the main flow path with respect to the flow rate detection flow path.

12. The physical quantity measurement device according to claim 1, wherein
a circuit unit that processes a signal output from the physical quantity detecting element and the temperature detecting element is mounted on the first mounting portion,
the housing has a physical quantity detection flow path through which air for detecting a physical quantity flows, and a temperature detection flow path that is different from the physical quantity detection flow path and through which air for detecting a temperature flows,
a part of the first mounting portion on which the physical quantity detecting element is mounted is arranged in the physical quantity detection flow path, and
the temperature detecting element is arranged in the temperature detection flow path.

13. The physical quantity measurement device according to claim 1, wherein
the housing has a sub-flow path through which a part of air flowing through a main flow path flows and a physical quantity detection flow path for detecting a physical quantity of air through which a part of air flowing through a sub-flow path flows,
the physical quantity detecting element is arranged in the physical quantity detection flow path, and
the temperature detecting element is located at a position different from the sub-flow path and the physical quantity detection flow path, and is arranged on the downstream side in the air flow direction of the main flow path with respect to an inlet of the sub-flow path.

14. The physical quantity measurement device according to claim 1, wherein
the first side surface of the root side part has a first flat part connected to the root and a second flat part connected to the tip part side with respect to the first flat part,
the second side surface of the root side part has a third flat part connected to the root and a fourth flat part connected to the tip part side with respect to the third flat part, and
a first angle formed by the second flat part and the fourth flat part is larger than a second angle formed by the first flat part and the third flat part.
